(19) United States
(12) Patent Application Publication
(10) Pub. No.: US 2004/0156193 A1
(43) Pub. Date: Aug. 12, 2004

(54) Flashlight

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/361,757

(22) Filed: Feb. 11, 2003

(51) Int. Cl. F21L 2/00

(52) U.S. Cl. 362/157

(57) ABSTRACT

A flashlight comprises a body, a gear set, a generator and a crank set. When rotating a handle of the crank set, a driving gear of the gear set links a first driven gear, a second driven gear and a third driven gear. Each of the driven gears has a different gear ratio, and the third driven gear then links a magnet to spin with respect to a coil within the generator to generate electricity and activate an illumination device and to light up a LED.

### FIELD OF THE INVENTION

This invention relates to a flashlight, and more particularly, to a flashlight with self-electrical generator to generate electrical power by a relative rotation movement of a magnet and a coil in the generator.

### BACKGROUND OF THE INVENTION

A flashlight has been widely used by consumers for its mobility and convenience. However, the flashlights on the market require batteries to operate, and have some shortcomings;

1. When the batteries are dead, the flashlight is useless unless new batteries are replaced.

2. In order to keep the flashlight work properly, spare batteries must be prepared, which is a waste of energy.

3. The dead batteries must be disposed properly in order not to cause environmental pollution.

### SUMMARY OF THE INVENTION

It is the primary object of the present invention to provide a flashlight, which saves energy and has a low cost.

It is another object of the present invention to provide a flashlight, which is environmental clean.

It is a further object of the present invention to provide a flashlight, which is easy to operate, and is suitable for emergency use.

### BRIEF DESCRIPTION OF THE DRAWINGS

FIG. 1 is an exploded view of the present invention;

FIG. 2 is a perspective view of the present invention;

FIG. 3 is a side cross-sectional view of the present invention; and

FIG. 4 is a side cross-sectional view showing a gear set of the present invention.

### DETAILED DESCRIPTION OF THE PREFERRED EMBODIMENT

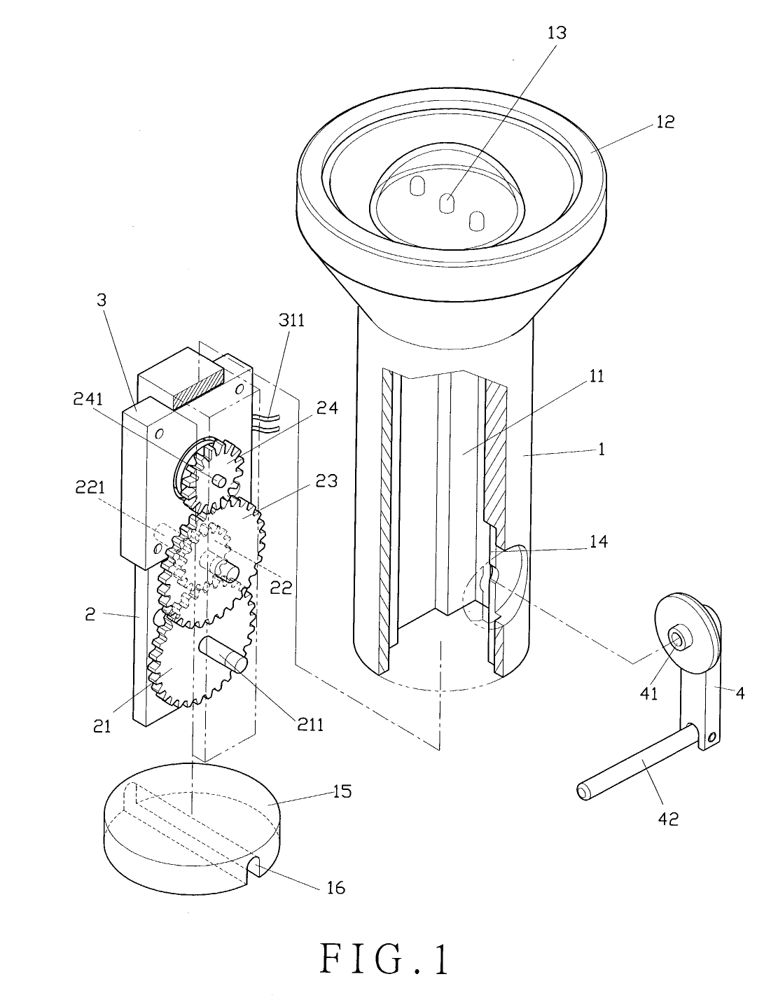

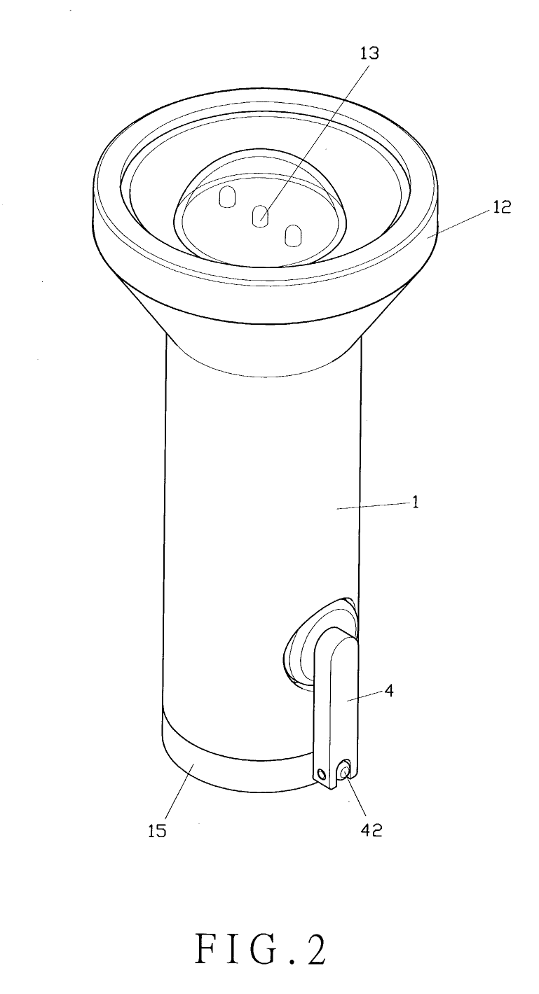

A flashlight of the present invention, as shown in FIGS. 1 and 2 comprises a body 1, a gear set 2, a generator 3 and a crank set 4.

The body 1 comprises a compartment 11 therein and an illumination device 12 at a front end. The illumination device 12 comprises at least one LED 13. The body 1 further comprises a slot 14 at one side and a lid 15 at a rear end thereof, with a trough 16 across a bottom end thereof.

The gear set 2 is placed in the compartment 11 of the body 1, and is composed of a first axle 211 with a driving gear 21 thereat, which meshes with a first driven gear 22 and a second driven gear 23. Both of the first driven gear 22 and the second driven gear 23 are fixed on a second axle 221. The second driven gear 23 meshes with a third driven gear 24 which is fixed on a third axle 241. The driving gear 21 and the second driven gear 23 are large gears, and the first driven gear 22 and the third driven gear 24 are small gears.

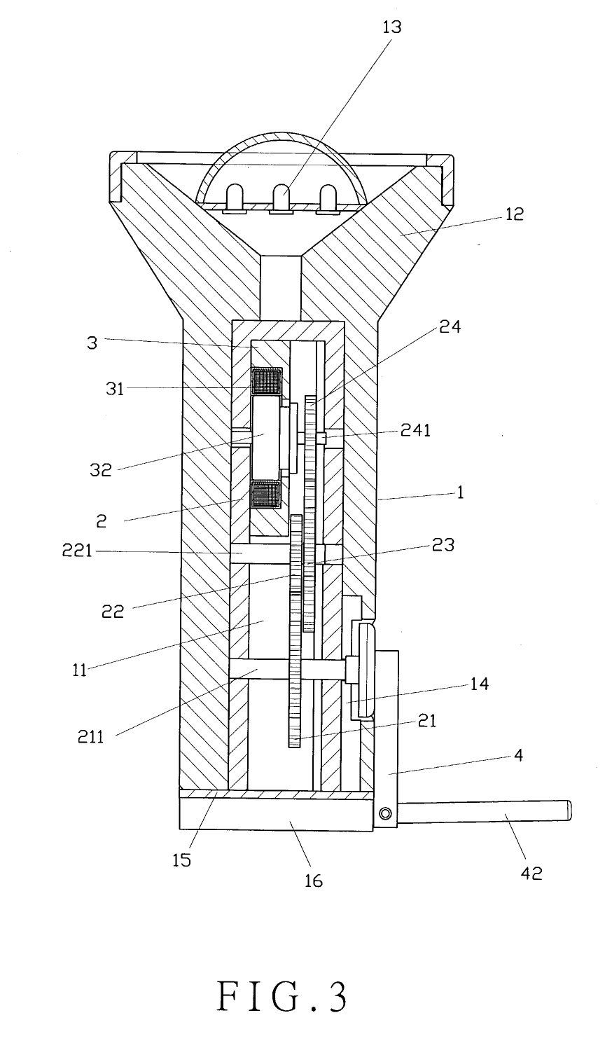

The generator 3 is secured on the gear set 2 and comprises a coil 31 therein, as shown in FIG. 3. The coil 31 comprises an electric cord 31 to connect with the LED 13, and surrounds a magnet 32 therein. The magnet 32 is secured with the third axle 241 of the driven gear 24, by a relative rotation movement of the magnet 32 and the coil 31 to produce electric power.

The crank set 4 is secured to the first axle 211, and comprises a hole 41 thereon and a foldable handle 42 at a lower end.

To assemble the present invention, as shown in FIG. 3, the gear set 2 is placed into the compartment 11 of the body 1 with the first axle 211 protruding from the slot 14 of the body 1. The first axle 211 is inserted into the hole 41 of the crank set 4. The body 1 is covered with the lid 15. The handle 42 is folded into the trough 16 of the lid 15, and the assembly is completed.

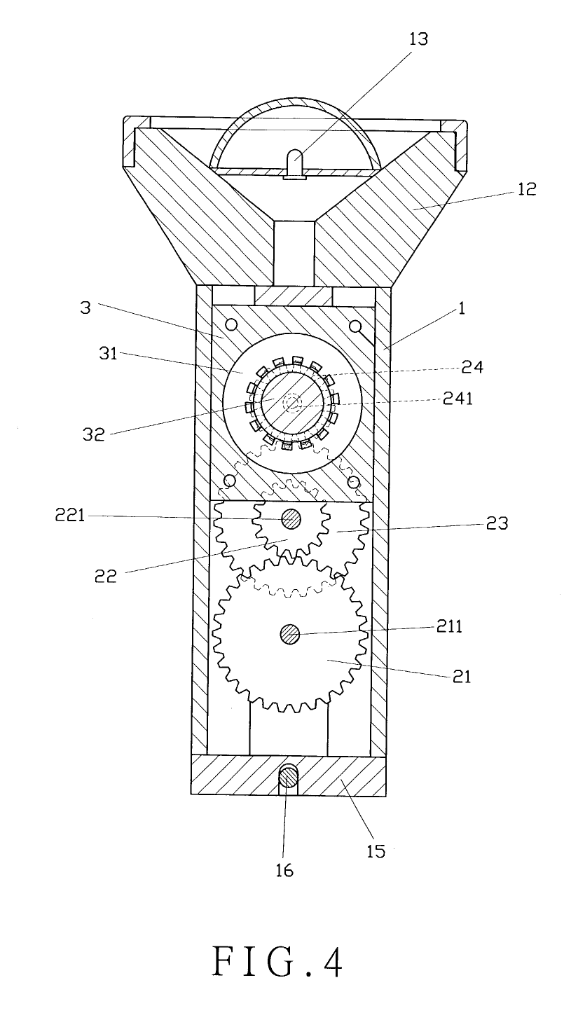

To operate the present invention, the handle 42 is unfolded with one hand and the body 1 is held with the other hand to spin the handle 42, which links the driving gear 21 through the first axle 211 to rotate, as shown in FIG. 4. The driving gear 21 links the first driven gear 22, the second driven gear 23 and the third driven gear 24 to rotate in sequence. The magnet 32 and the coil 31 on the third axle 241 of the third driven gear 24 are linked to rotate in a relative movement with each other to generate electric power, which transmits through the electric cord 311 to activate the LED 13.

I claim:

1. A flashlight comprising a body, a gear set, a generator and a crank set, wherein said body comprising a compartment therein and an illumination device at a front end, said illumination device comprising at least one LED, and said body further comprising a lid at a rear end thereof,
said gear set being placed in said compartment of said body, said gear set comprising a driving gear linking a first driven gear and a second driven gear, said second driven gear then linking a third driven gear, all said driving gear, said first driven gear, said second driven gear and said third driven gear having different gear ratios;
said generator being secured onto said gear set, and comprising a coil with an electric cord connected to said LED, said coil surrounding a magnet therein, which being linked by said third driven gear;
said crank set being secured on a first axle of said gear set.

2. The flashlight, as recited in claim 1, wherein said crank set comprises a hole and a handle, and said led comprises a trough across a bottom end thereof.

3. The flashlight, as recited I claim 1, wherein said body comprises a slot at one side thereof.

4. The flashlight, as recited in claim 1, wherein said first driven gear and said second driven gear are both secured onto a second axle, and said third driven gear is secured onto a third axle.

5. The flashlight, as recited in claim 1, wherein said driving gear and said second driven gear are large gears while said first driven gear and said third gear are small gears.
